(19) United States
(12) Patent Application Publication
(10) Pub. No.: US 2023/0140422 A1
(43) Pub. Date: May 4, 2023

(54) RADAR SELF-CALIBRATION DEVICE AND METHOD

(71) Applicant: CUBTEK INC., Zhubei City (TW)

(72) Inventors: SHYH-JONG CHUNG, Hsinchu County (TW); WEN-CHENG WANG, Hsinchu County (TW)

(73) Assignee: CUBTEK INC., Zhubei City (TW)

(21) Appl. No.: 17/947,387

(22) Filed: Sep. 19, 2022

(30) Foreign Application Priority Data
Oct. 28, 2021 (TW) 110140170

(51) Int. Cl. G01S 7/40; G01S 13/931

(52) U.S. Cl. CPC G01S 7/403; G01S 7/40; G01S 13/931

(57) ABSTRACT

A radar self-calibration device and method are disclosed. The device includes an antenna transceiver module and a processor. The antenna transceiver module has a detection range. The processor is coupled with the antenna transceiver module for obtaining a relative velocity and an angle of the object with respect to the antenna transceiver module in a period of time. The relative angle is the angle included between the object and the driving direction of the vehicle body with respect to the vehicle body. The processor determines if the relative angle is equal to an ideal angle according to a detection model. The detection condition of the detection model includes that when the relative velocity is 0, the ideal angle is 90 degrees. Thus, the present invention assures the correctness of the detected angle through the detection model. When the detected angle is incorrect, the error is promptly calibrated.

### BACKGROUND OF THE INVENTION

### 1. Field of the Invention

The present invention relates to self-calibration techniques, and more particularly, to a radar self-calibration device and method thereof.

### 2. Description of the Related Art

A vehicle radar is calibrated in advance before being installed on the vehicle body. However, when the vehicle radar is practically installed on the vehicle, due to the poor accuracy of the initial operation of the radar installation, reference axis of the radar deviates from the originally designed direction, causing an issue of an incorrect direction angle of the object obtained after the echo processing operation of the radar.

Also, even if the deviation of the radar reference axis does not occur in the initial installation stage, in the subsequent use of the radar, the long-term driving, age, and possible collision of the vehicle body will affect the radar, causing an abnormal detection due to the deviation of the radar reference axis.

When an abnormal object detection occurs, because the object status is misjudged and the correct observation value is unable to be obtained, a stationary object may be detected as a moving object. Besides, due to the incorrect position of the object relative to the vehicle body, the applications such as blind spot detection (BSD), rear cross traffic alert (RCTA), and door open warning (DOW), may suffer from false alarms, missed alarms, and abnormal real-time alarms.

### SUMMARY OF THE INVENTION

The present invention aims at providing a radar self-calibration device and method thereof for promptly determining the deviation of radar angle and carrying out the calibration process.

For achieving the aforementioned objectives, an embodiment of the present invention provides a radar self-calibration device, which is installed on a vehicle body and configured to carry out an angular error detection according to an object on one side of the vehicle body, the radar self-calibration device comprising:

an antenna transceiver module having a detection range; and

a processor coupled with the antenna transceiver module and configured to obtain a relative velocity and a relative angle of the object with respect to the antenna transceiver module in a period of time, the relative angle being an angle included between the object and the driving direction of the vehicle body with respect to the vehicle body, the processor determining if the relative angle is equal to an ideal angle according to a detection model;

wherein, a detection condition of the detection model comprises that when the relative velocity is 0, the ideal angle is 90 degrees.

An embodiment of the present invention provides a radar self-calibration method, wherein a vehicle body comprises an antenna transceiver module, and the antenna transceiver module is configured to detect an object on one side of the vehicle body, the radar self-calibration method comprising following steps:

a capturing step, a processor obtaining a relative velocity and a relative angle of the object with respect to the antenna transceiver module in a period of time, the relative angle being an angle included between the object and the driving direction of the vehicle body with respect to the vehicle body;

a processing step, the processor inputting the relative velocity and the relative angle into a detection model; and

a determining step, the processor determining if the relative angle is equal to an ideal angle according to the detection model for confirming if the angle detected by the antenna transceiver module is correct. Therein, the detection condition of the detection model includes that when the relative velocity is 0, the ideal angle is 90 degrees.

With such configuration, after obtaining the relative velocity and the relative angle of the object with respect to the antenna transceiver module in a period of time, the radar self-calibration device of the present invention is able to confirm the correctness of the angle detected by the antenna transceiver module. When the detection shows error, the detection model and promptly carries out the subsequent process, so as to prevent the abnormal detection caused by the deviation of the reference axis of the antenna transceiver module, thereby specifically determining the status of the object and obtaining a correct observation value, ensuring the driving safety.

### BRIEF DESCRIPTION OF THE DRAWINGS

FIG. 1 is a structural block view of the radar self-calibration device in accordance with an embodiment of the present invention.

FIG. 2 is a flow chart of the radar self-calibration method in accordance with an embodiment of the present invention.

FIG. 3A is a schematic view of the relative positions of the vehicle body and the object, illustrating the vehicle body not moving pass the object yet.

FIG. 3B is another schematic view of the relative positions of the vehicle body and the object, illustrating the vehicle body currently moving pass the object, and the object being right next to the vehicle body.

FIG. 3C is another schematic view of the relative positions of the vehicle body and the object, illustrating the vehicle body already moved pass the object.

FIG. 4 is a schematic view of the detection curve in accordance with an embodiment of the present invention.

FIG. 5 is a schematic view of the driving model in accordance with an embodiment of the present invention.

FIG. 6 is another schematic view of the driving model in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion, size, modification or displacement amount for explanation but not subject to the actual component proportion.

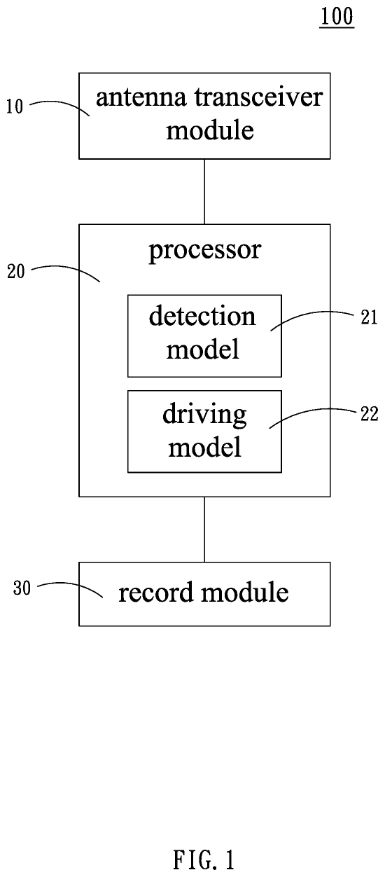

Referring to FIG. 1 to FIG. 6, the present invention provides a radar self-calibration device 100 and a radar self-calibration method 200. The radar self-calibration device 100 is installed on a vehicle body 1 and is configured to carry out an angular error detection according to an object 2 on one side of the vehicle.

The radar self-calibration device 100 comprises an antenna transceiver module 10, a processor 20, and a record module 30 that are coupled with each other. The processor 20 is communicatively connected with the controller area network bus (CAN bus) of the vehicle body 1. In the embodiment, the antenna transceiver module 10 is disposed on a lateral side of the vehicle body 1. Alternatively, the antenna transceiver module 10 is allowed to be installed on the front or rear side of the vehicle body 1 as long as it is capable of carrying out the radar detection operation toward the lateral side of the vehicle. The processor 20 is a digital signal processor (DSP). Alternatively, the processor 20 is allowed to be a chip or model capable of carrying out a signal calculation.

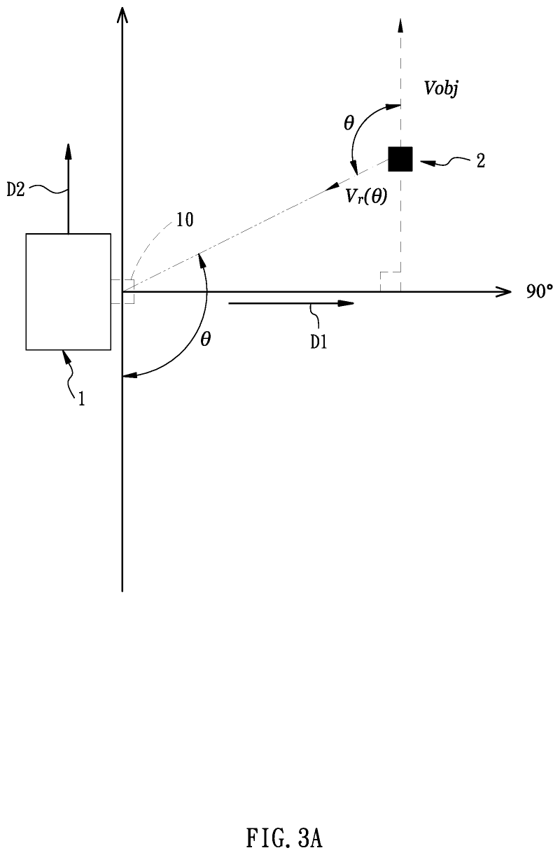

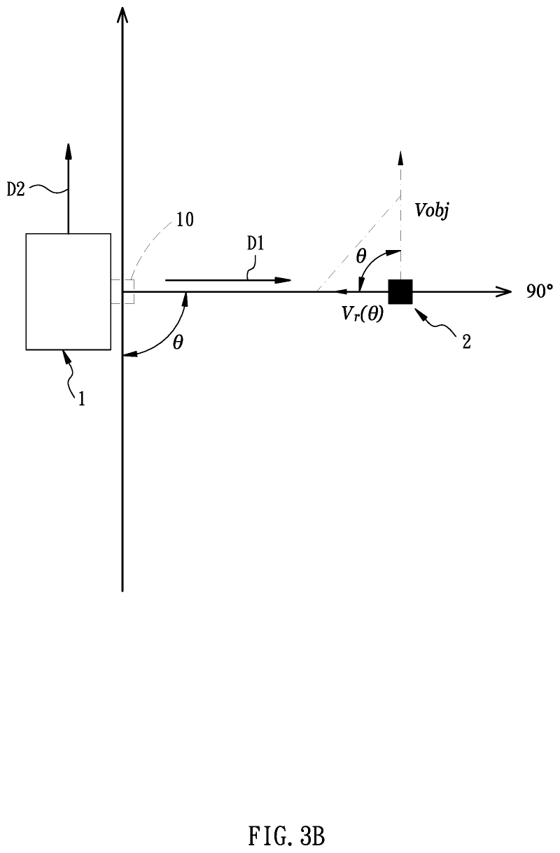

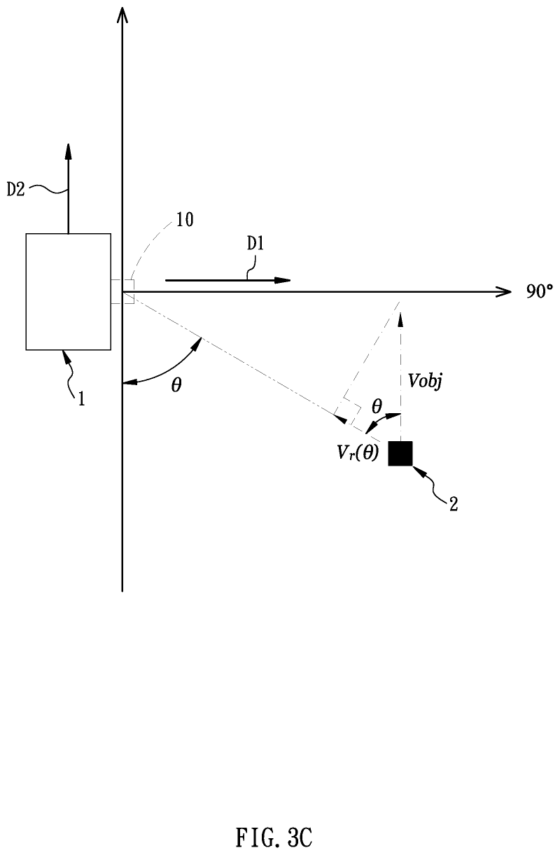

The antenna transceiver module 10 has a detection range. As shown by FIG. 3A, the driving direction D2 is the moving direction of the vehicle body 1, and the perpendicular detection direction D1 is the detection direction perpendicular to the driving direction D2 in the detection range of the antenna transceiver module 10. The antenna transceiver module 10 emits an electromagnetic signal toward the detection range and receives the echo signal reflected by the object 2 in the detection range.

The processor 20 obtains a relative velocity Vᵣ(θ) and a relative angle θ of the object 2 with respect to the antenna transceiver module 10 in a period of time, and accordingly confirms if the relative angle θ is equal to an ideal angle according to a detection model 21.

The detection model 21 is saved in the processor 20 in advance. In the embodiment, the detection model 21 is Vᵣ(θ)=V_{obj}*cos(θ). Therein, the relative velocity Vᵣ(θ) represents the relative velocity between the vehicle body 1 and the object 2 with the directionality thereof taken into consideration. The parallel velocity V_{obj} represents the velocity of the object 2 in a direction parallel to the driving direction D2 with respect to the vehicle body 1. The relative angle θ is the angle included between the object 2 and the driving direction D2 of the vehicle body 1 with respect to the vehicle body 1.

Obviously in the embodiment, a detection condition of the said detection model 21 is set as: when the relative velocity Vᵣ(θ) is 0, the ideal angle is 90 degrees. In other words, when the vehicle body 1 moves pass the object 2, and the direction of Vᵣ(θ) is equal to the perpendicular detection direction D1, the relative angle θ is equal to 90 degrees, and theoretically, the Vᵣ(θ) does not have a velocity. Therefore, such property is used for determining if the detection angle of the antenna transceiver module 10 is correct.

Also, the record module 30 is allowed to be, for example, a storage hard disk or flash memory for recording the immediate value of the relative velocity Vᵣ(θ) and the relative angle θ in the certain period of time. The processor 20 is able to obtain a driving model 22 of the vehicle body 1 with respect to the object 2 through the recording module 30, so as to carry out a comparison between the information provided by the driving model 22 and the detection model 21, thereby confirming the correctness of the detected angle of the antenna transceiver module 10.

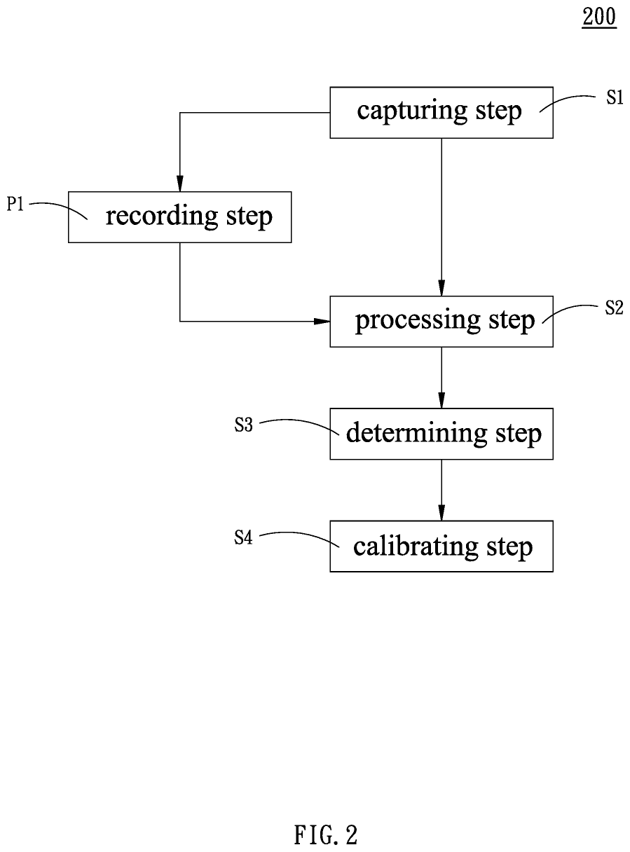

The foregoing content is to illustrate an embodiment of the radar self-calibration device 100 of the present invention. The following content is to illustrate a radar self-calibration method 200 of the radar self-calibration device 100. Referring to FIG. 2, the method comprises a capturing step S1, a processing step S2, a determining step S3, and a calibrating step S4. Also, the embodiment further comprises a recording step P1.

In the capturing step S1, the processor 20 obtains the relative velocity Vᵣ(θ) and the relative angle θ of the object 2 with respect to the antenna transceiver module 10 in a period of time. To further explain, during the moving process of the vehicle body 1, the antenna transceiver module 10 emits an electromagnetic signal toward the detection range through the antenna and receives the echo signal reflected by the object 2 in the detection range. The processor 20 obtains the echo signal of the antenna transceiver module 10 and carries out an analog-to-digital conversion and Fourier transform with the echo signal, thereby obtaining the relative velocity Vᵣ(θ) and the relative angle θ.

In the embodiment, when the object 2 is stationary, and the driving direction D2 of the vehicle body 1 and the object 2 are not on the same straight line, the processor 20 is able to respectively apply two error-detection methods for confirming if the detected angle of the antenna transceiver module 10 is correct based on the fact that the vehicle body 1 moves pass the object 2 or not.

If the vehicle body 1 will move pass the object 2 (as shown by FIG. 3A to FIG. 3C), in the capturing step S1, the processor 20 obtains the relative velocity Vᵣ(θ) and the relative angle θ of the object 2 with respect to the antenna transceiver module 10 in a period of time.

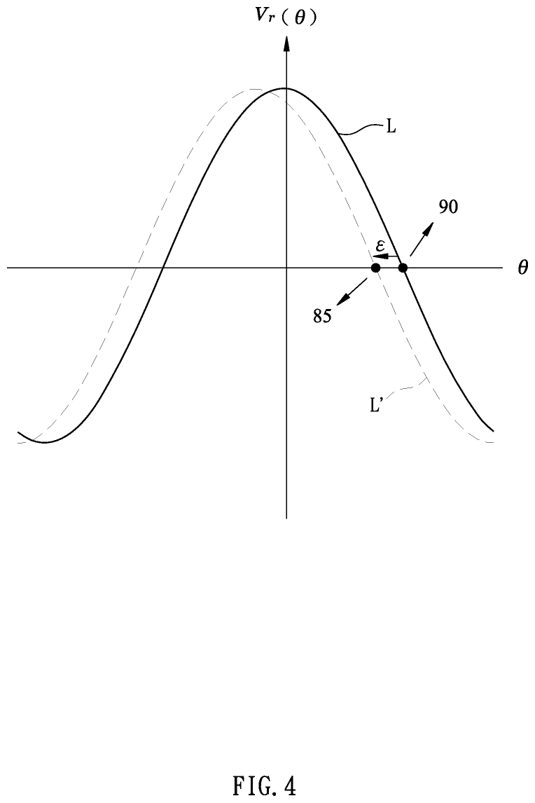

In the processing step S2, the processor 20 inputs the relative velocity Vᵣ(θ) and the relative angle θ into the detection model 21, so as to draw an actual detection curve L′. In the processing step S2 of the embodiment, when the antenna transceiver module 10 is correctly installed with any angular errors, the actual detection curve L′ drawn by the processor 20 according to the pre-stored detection model 21 is an ideal detection curve L (as shown by FIG. 4).

In the detection curve drawn by the processor 20, the relative velocity Vᵣ(θ) varies according to the angle of the vehicle body 1 with respect to the object 2. According to the detection condition set in the detection model 21, at the moment the vehicle body 1 moves pass the object 2, in which the direction of Vᵣ(θ) is the perpendicular detection direction D1 (as shown by FIG. 3B), the ideal relative angle θ is 90 degrees, and the relative velocity Vᵣ(θ) is equal to 0.

In other words, when the relative velocity Vᵣ(θ) actually obtained by the processor 22 is 0, the relative angle θ is theoretically equal to the ideal angle, which is 90 degrees. Therefore, when the relative velocity Vᵣ(θ) obtained by the processor 22 is 0, but the corresponding relative angle θ is not equal to 90 degrees, the angle detected by the antenna transceiver module 10 is incorrect.

In the determining step S3, at the moment of the vehicle body 1 moving pass the object 2 and the relative velocity Vᵣ(θ) in the actual detection curve L′ being 0, the processor 20 confirms if the corresponding relative angle θ is equal to the ideal angle which is 90 degrees based on the detection model 21, so as to determine if the detected angle of the antenna transceiver module 10 has any error. If the relative angle θ is not equal to the ideal angle which is 90 degrees, the detected angle of the antenna transceiver module 10 is incorrect, and the method 200 proceeds to the subsequent calibrating step S4.

Besides, there is another situation that the vehicle body 1 will not move pass the object 2. Before the vehicle body 1 moves pass the object 2, the vehicle body 1 may possibly turn or faces other conditions. Therefore, in the embodiment, the present invention is still capable of carrying out the angular error detection operation when the vehicle body 1 does not move pass the object 2. Therein, the recording step P1 is added after the capturing step S1. In the recording step P1, the record module 30 records the immediate values of the relative velocity Vᵣ(θ) and the relative angle θ of the object 2 obtained by the processor 20, so as to carry out the angular error detection operation by establishing the driving model 22.

In the processing step S2, the processor 20 inputs the relative velocity Vᵣ(θ) and the relative angle θ recorded by the recording module 30 into the detection model 21, so as to obtain the driving model 22 of the vehicle body 1 with respect to the object 2.

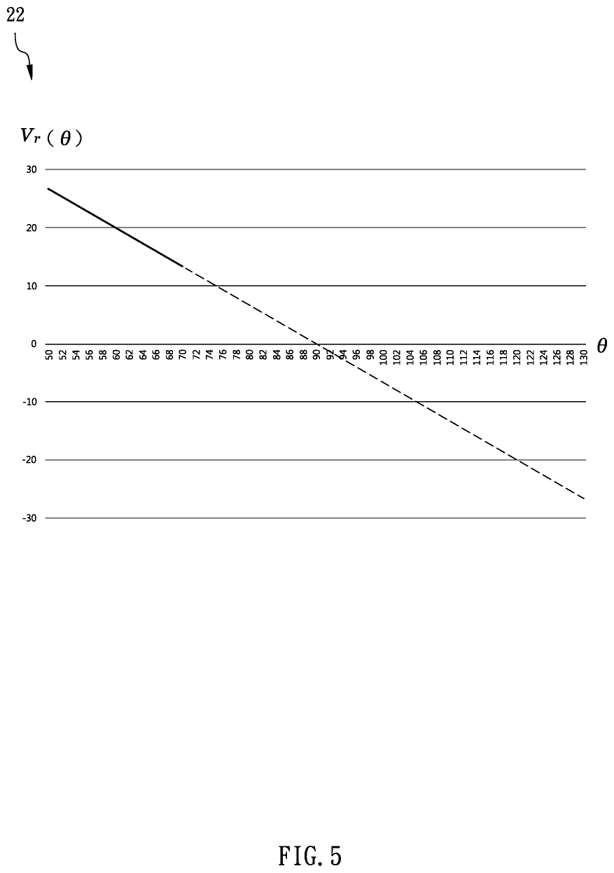

In the embodiment, based on the relative velocity Vᵣ(θ) in a certain range of the relative angle θ recorded by the recording module 30, the processor 20 converts the relative velocity Vᵣ(θ) and the relative angle θ into a linear curve for establishing the driving model 22 (as shown by FIG. 5), so as to estimate the value of the relative angle θ when the relative velocity Vᵣ(θ) is 0 through the driving model 22. Therein, the X axis of the driving model 22 is the relative angle θ, and the Y axis is the relative velocity Vᵣ(θ).

Next, in the determining step S3, the processor 20 compares the information provided by the driving model 22 with the detection model 21, so as to confirm the correctness of the detection angle of the antenna transceiver model 10. If the corresponding relative angle θ is not the ideal angle which is 90 degrees, it means that the detected angle of the antenna transceiver module 10 is incorrect, and the method 200 proceeds to the subsequent calibrating step S4.

For example, when the vehicle body 1 does not move pass the object 2, in the recording step P1, the record module 30 records the relative angle θ and the relative velocity Vᵣ(θ) between the vehicle body 1 and the object 2 once per 0.1 seconds in a 5-second period of time during the driving process of the vehicle body 1. In the processing step S2, according to the record module 30, the processor 20 converts the recorded instant values of the relative velocity Vᵣ(θ) with respect to the relative angle θ ranging from 50 degrees to 70 degrees into a linear curve for establishing the driving model 22 (as shown by FIG. 5). Based on this driving model 22, at the moment the vehicle body 1 moving pass right next to the object 2 where the direction of Vᵣ(θ) is equal to the perpendicular detection direction D1 and the relative velocity Vᵣ(θ) is 0, the processor 20 is able to estimate the value of the corresponding relative angle θ. In this driving model 22, the processor 20 estimates that when the relative velocity Vᵣ(θ) is 0, the value of the corresponding relative angle θ is 90 degrees. In the determining step S3, from the driving model 22, the processor 20 obtains the fact that when the relative velocity Vᵣ(θ) is 0, the value of the corresponding relative angle θ is 90 degrees. After the comparison with the detection model 21, it is confirmed that the antenna transceiver module 10 is correctly installed, and the detected angle is correct.

Also, when the object 2 is a moving object, and the driving direction D2 of the vehicle body 1 is parallel to and not on the same straight line of the moving direction of the object 2, the processor 20 is still able to apply the two aforementioned error detection ways to confirm if the detected angle of the antenna transceiver module 10 based on the fact that the vehicle body 1 moves pass the object 2 or not.

In the situation where the vehicle body 1 will move pass the object 2 (as shown by FIG. 3A to FIG. 3C), in the capturing step S1, the processor 20 obtains the relative velocity Vᵣ(θ) and the relative angle θ of the object 2 with respect to the antenna transceiver module 10 in a period of time.

In the processing step S2, the processor 20 inputs the relative velocity Vᵣ(θ) and the relative angle θ into the detection model 21 to draw an actual detection curve L′.

In the determining step S3, according to the detection condition of the detection model 21, even if the object 2 is in a moving status, as long as a velocity difference exists between the vehicle body 1 and the object 2, the processor 20 confirms if the relative angle θ is equal to the 90-degree ideal angle at the moment the vehicle body 1 moving pass right next to the object 2 where the direction of Vᵣ(θ) is equal to the perpendicular detection direction D1 (as shown by FIG. 3B) and the relative velocity Vᵣ(θ) in the actual detection curve L′ is 0, thereby determining if the antenna transceiver module 10 have any angular errors. If the relative angle θ is not equal to the 90-degree ideal angle, it means that the detected angle of the antenna transceiver module 10 is incorrect, and the method 200 proceeds to the subsequent calibrating step S4.

Even the velocity difference between the vehicle body 1 and the object 2 is not sufficient for the vehicle body 1 to move pass the object 2, in the embodiment, a recording step P1 is able to be added after the capturing step S1. In the recording step P1, the record module 30 records the instant values of the relative velocity Vᵣ(θ) and the relative angle θ of the object 2 obtained by the processor 20, so as to establish the driving model 22 for angular error detection. The detailed process is described as follows.

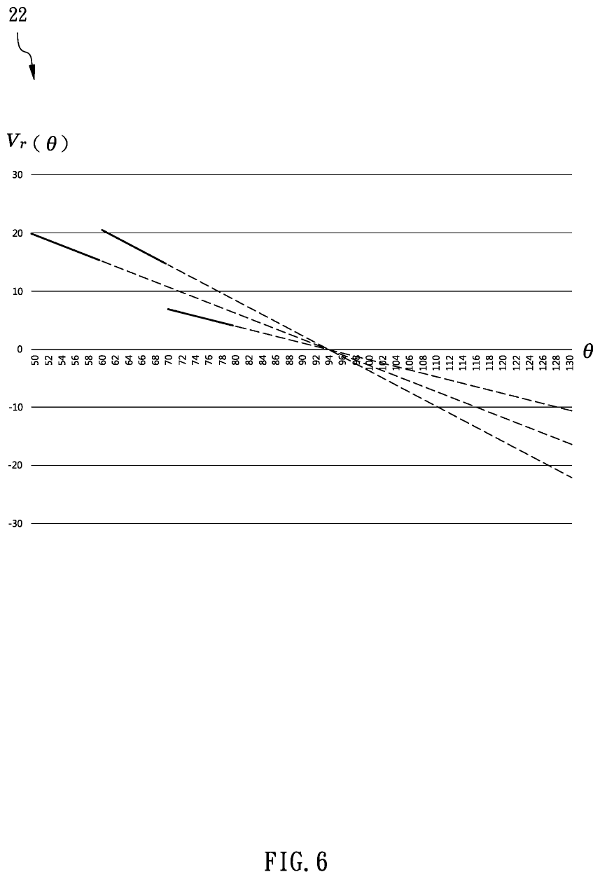

In the processing step S2, the processor 20 inputs the relative velocity Vᵣ(θ) and the relative angle θ recorded by the record module 30 into the detection model 21, so as to obtain the driving model 22 of the vehicle body 1 with respect to the object 2 (as shown by FIG. 6).

In the embodiment, because the parallel velocity V_{obj} of the object 2 would not stay unchanged, the processor 20 is able to draw out the relative velocity Vᵣ(θ) and the relative angle θ according to the relative velocity Vᵣ(θ) corresponding to a certain range of the relative angle θ recorded by the record module 30 when the object 2 is moving, so as to form a plurality of linear curves and establish the driving model 22. Therein, the X axis of the driving model 22 is the relative angle θ, and the Y axis is the relative velocity Vᵣ(θ).

Therein, the relative velocity Vᵣ(θ) of the plurality of linear curves in the driving model 22 changes based on the parallel velocity V_{obj} of itself with respect to the object 2, so as to present a linear curve having a corresponding slope. Because the processor 20 obtains the relative angle θ through an identical antenna transceiver module 10, the values of the corresponding relative angle θ are theoretically the same at the moment the vehicle body 1 moving pass right next to the object 2 where the relative velocity Vᵣ(θ) is 0. In other words, the linear curves will cross at the same relative angle θ when the relative velocity Vᵣ(θ) is 0.

Then, in the determining step S3, the processor 20 compares the information provided by the driving model 22 and the detection model 21 to confirm if the angle detected by the antenna transceiver module 10 is correct. If the corresponding relative angle θ is not the ideal angle which is 90 degrees, it means that the detected angle of the antenna transceiver module 10 is incorrect, and the method 200 proceeds to the subsequent calibrating step S4.

For example, during the process of the vehicle body 1 approaching the object 2, the object 2 moves at a velocity of 30 m/s for a period of time, and then accelerates to 40 m/s and keeps moving for a period of time, and then reduces to 20 m/s and keeps moving for a period of time. In the recording step P1, the record module 30 records the actually detected relative velocity Vᵣ(θ) and relative angle θ of the vehicle body 1 with respect to the object 2 once per 0.1 seconds in a 5-second period of time during the moving process of the vehicle body 1 approaching the object 2. In the processing step S2, as shown by FIG. 6, according to the instant values of the relative velocity Vᵣ(θ) corresponding to three moving velocities with respect to the relative angle θ ranging from 50 degrees to 80 degrees recorded by the record module 30, the processor 20 draws out the three linear curves established by relative velocity Vᵣ(θ) and the relative angle θ to establish the driving model 22. Based on the driving model 22, the processor 20 estimates that the value of the corresponding relative angle θ is 94 degrees at the moment the vehicle body 1 moving pass the object 2 where the relative velocity Vᵣ(θ) is 0. In the determining step S3, based on the driving model 22, the processor 20 obtains the fact that when the relative velocity Vᵣ(θ) is 0, the value of the corresponding relative angle θ at which the three linear curves cross is 94 degrees. After comparing to the detection model 21, the corresponding relative angle θ is not the 90-degree ideal angle. Therefore, it is determined that the angle detected by the antenna transceiver module 10 is incorrect, and the method 200 needs to proceed to the subsequent calibrating step S4.

In the calibrating step S4, the processor 20 subtracts the relative angle θ obtained when the relative velocity Vᵣ(θ) is 0 from the 90-degree ideal angle to get a deviation amount ε, so as to carry out the calibration of the detected angle according to the deviation amount ε.

In the embodiment, the calibration of the detected angle comprises a passive calibration and an active calibration.

Regarding the passive calibration, the processor 20 carries out a self-compensation through a software according to the deviation amount ε, so as to ensure that the subsequently obtained relative angle θ is correct. For example, as shown by FIG. 4, the relative angle θ obtained by the processor 20 according to the actual detection curve L′ is 85 degrees, so that the processor 20 subtracts 85 degrees from 90 degrees to get a 5-degree deviation amount ε. Thus, in the subsequent capturing step S1, the processor 20 immediately adds 5 degrees to the obtained relative angle θ, so that the relative angle θ is the correct detected angle.

Regarding the active calibration, the processor 20 applies a physical adjustment method, using a gyroscope and a servo motor with a movable bracket to rotate the reference axis of the antenna transceiver module 10 according to the deviation amount ε, thereby mechanically adjusting the detected angle of the antenna transceiver module 10, ensuring that the relative angle θ is correctly detected.

With the foregoing configuration, the present invention achieves following advantages.

With the detection model 21 of the present invention, if the relative angle θ obtained by the processor 20 is not equal to 90 degrees when the relative velocity Vᵣ(θ) is 0, it can be determined that the angle detected by the antenna transceiver module 10 is incorrect. Thus, the present invention efficiently and accurately determines if the angle detected by the antenna transceiver module 10 is correct.

The object 2 used for error detection by the present invention is not limited to stationary objects. Because the ideal angle of the detection model 21 has an only solution, as long as the driving direction D2 of the vehicle body 1 is parallel to and not on the same straight line with the moving direction of the object 2, the error detection operation of the angle is able to be carried out.

Also, when the processor 20 determines that the angle detected by the antenna transceiver module 10 is incorrect, the processor 20 is able to immediately carry out the calibration, so as to prevent the detection abnormality caused by deviation of the reference axis of the antenna transceiver module 10, thereby specifically determining the status of the object 2, obtaining the correct observation value, and ensuring the driving safety.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A radar self-calibration device disposed on a vehicle body and carrying out an error detection according to an object on one side of the vehicle body, the radar self-calibration device comprising:
an antenna transceiver module having a detection range; and
a processor coupled with the antenna transceiver module and configured to obtain a relative velocity and a relative angle of the object with respect to the antenna transceiver module in a period of time, the relative angle being an angle included between the object and the driving direction of the vehicle body with respect to the vehicle body, the processor determining if the relative angle is equal to an ideal angle according to a detection model; wherein
a detection condition of the detection model comprises that when the relative velocity is 0, the ideal angle is 90 degrees.

2. The radar self-calibration device of claim 1, wherein the detection model is Vᵣ(θ)=V_{obj}*cos(θ), wherein the Vᵣ(θ) is the relative velocity, the θ is the relative angle, the V_{obj} is a parallel velocity, and the parallel velocity represents a velocity of the object in a direction parallel to the driving direction with respect to the vehicle body.

3. The radar self-calibration device of claim 1, wherein the object is a stationary object, and the driving direction of the vehicle body and the object are not on a same straight line.

4. The radar self-calibration device of claim 1, wherein the object is a moving object, the driving direction of the vehicle body is parallel to and not on a same straight line with the moving direction of the object.

5. The radar self-calibration device of claim 1, further comprising a record module coupled with the processor and the antenna transceiver module, the record module being configured to record an instant value of the relative velocity and the relative angle in the period of time, the processor obtaining a driving model of the vehicle body with respect to the object through the record module, so as to compare the driving model with the detection model for confirming if the angle detected by the antenna transceiver module is correct.

6. The radar self-calibration device of claim 1, wherein when the processor determines that the angle detected by the antenna transceiver module is incorrect, the processor subtracts the relative angle from the ideal angle to get a deviation amount, so as to carry out an angle calibration according to the deviation amount.

7. The radar self-calibration device of claim 1, wherein the antenna transceiver module is installed on a lateral side of the vehicle body.

8. A radar self-calibration method, wherein a vehicle body comprises an antenna transceiver module, and the antenna transceiver module is configured to detect an object on one side of the vehicle body, the radar self-calibration method comprising following steps:
a capturing step: a processor obtaining a relative velocity and a relative angle of the object with respect to the antenna transceiver module in a period of time, the relative angle being an angle included between the object and the driving direction of the vehicle body with respect to the vehicle body;
a processing step: the processor inputting the relative velocity and the relative angle into a detection model; and
a determining step: the processor determining if the relative angle is equal to an ideal angle according to the detection model for confirming if the angle detected by the antenna transceiver module is correct; wherein
a detection condition of the detection model comprises that when the relative velocity is 0, the ideal angle is 90 degrees.

9. The radar self-calibration method of claim 8, wherein the detection model is Vᵣ(θ)=V_{obj}*cos(θ), wherein the Vᵣ(θ) is the relative velocity, the θ is the relative angle, the V_{obj} is a parallel velocity, and the parallel velocity represents a velocity of the object in a direction parallel to the driving direction with respect to the vehicle body.

10. The radar self-calibration method of claim 8, wherein the object is a stationary object, and the driving direction of the vehicle body and the object are not on a same straight line.

11. The radar self-calibration method of claim 8, wherein the object is a moving object, the driving direction of the vehicle body is parallel to and not on a same straight line with the moving direction of the object.

12. The radar self-calibration method of claim 8, further comprising a recording step: a record module recording an instant value of the relative velocity and the relative angle in the period of time; in the processing step, the processor obtaining a driving model of the vehicle body with respect to the object according to the recorded relative velocity and relative angle; in the determining step, the processor comparing the driving model with the detection model for confirming if the angle detected by the antenna transceiver module is correct.

13. The radar self-calibration method of claim 8, further comprising a calibrating step: the processor subtracting the relative angle from the ideal angle to get a deviation amount, so as to carry out an angle calibration according to the deviation amount.

14. The radar self-calibration method of claim 13, wherein, after the calibrating step, the processor carries out a self-compensation according to the deviation amount, so as to ensure that the subsequently obtained relative angle is correct.

15. The radar self-calibration method of claim 13, wherein, in the calibrating step, a reference axis of the antenna transceiver module is rotated to adjust the angle detected by the antenna transceiver module.
